(19) United States
(12) Patent Application Publication
(10) Pub. No.: US 2024/0018971 A1
(43) Pub. Date: Jan. 18, 2024

(54) FLUID PUMP

(71) Applicant: MAHLE INTERNATIONAL GMBH, Stuttgart (DE)

(72) Inventors: Alok AWASARE, Pune (IN); Martin Gross, Kämpfelbach (DE)

(21) Appl. No.: 18/210,249

(22) Filed: Jun. 15, 2023

(30) Foreign Application Priority Data
Jun. 20, 2022 (DE) 102022206143.8

(51) Int. Cl. F04D 29/42; F04D 13/06

(52) U.S. Cl. CPC F04D 29/426; F04D 13/06

(57) ABSTRACT

The invention relates to a fluid pump (1). The fluid pump (1) includes an impeller unit (2) having an impeller (4) and an impeller housing (3) and to an electric motor (6) having a motor housing (10). On the impeller housing (3), a fluid inlet (5a) and a fluid outlet (5b) are formed. The impeller housing (3) is firmly connected to the motor housing (10) by means of a fastening unit (30).

It is substantial that the fluid outlet (5b) with respect to the motor housing (10) can be arranged in one of at least two possible positions (P1.1, P2.1), wherein the possible positions (P1.1, P2.1) differ from one another by an angle of rotation (DW).

### CROSS-REFERENCE TO RELATED APPLICATIONS

This application claims priority from German Patent Application No. DE 10 2022 206 143.8, filed on Jun. 20, 2022, the entirety of which is hereby incorporated by reference herein.

The invention relates to a fluid pump for a fuel cell system having at least one fuel cell stack of multiple fuel cells according to the preamble of claim 1.

Fluid pumps are already known from the prior art and include an impeller for delivering a fluid and an electric motor for driving the impeller. Among other things, fluid pumps can be employed for cooling a fuel cell system. The fuel cell system comprises multiple fuel cell stacks which are cooled by means of a fluid delivered by the fluid pump. With respect to its construction, the fluid pump is usually adapted to a given application. However, there is more frequently the requirement to adapt the fluid pump with a reduced effort to another application. However, this requires an elaborate and cost-intensive conversion or reconstruction of the fluid pump.

The object of the invention therefore is to state for a fluid pump of the generic type an improved or at least alternative embodiment with which the described disadvantages are overcome.

According to the invention, this object is solved through the subject of the independent claim 1. Advantageous embodiments are subject of the dependent claims.

The present invention is based on the general idea of configuring the electric motor of the fluid pump as a basic unit and the impeller unit of the fluid pump so as to be replaceable, so that for differing applications merely the impeller unit or an impeller housing of the impeller unit with inlet/outlet connector has to be replaced.

A fluid pump is provided for a fuel cell system having at least one fuel cell stack of multiple fuel cells. The fluid pump comprises an impeller unit for delivering a cooling fluid having an impeller that is rotatable about an axis of rotation in a direction of rotation and an impeller housing accommodating the impeller. In addition, the fluid pump comprises an electric motor for driving the impeller with a motor housing. The impeller unit is arranged at a, with respect to the axis of rotation, axial longitudinal end of the motor and the impeller housing is firmly connected to the motor housing by means of a fastening unit. In addition, a fluid inlet of the impeller unit and a fluid outlet of the impeller unit are formed on the impeller housing. The fluid inlet is oriented axially with respect to the axis of rotation and the fluid outlet is oriented corresponding to the direction of rotation and tangentially to a circumferential line which, spaced apart, is circumferential to the axis of rotation. According to the invention, the impeller unit and the motor are designed in such a manner that the fluid outlet of the impeller unit, with respect to the motor housing, can be arranged in one of at least two possible positions. The at least two possible positions differ from one another by an angle of rotation about the axis of rotation in the direction of rotation.

In the fluid pump according to the invention, the fluid outlet of the impeller unit can have the at least two positions differing from one another. The motor and/or the motor housing and/or the fastening unit remain unchanged. Because of this, the fluid pump can be more easily adapted to a differing application by replacing or rotating the impeller housing or the impeller unit. The respective possible positions differ by the angle of rotation about the axis of rotation in the direction of rotation. The one position can be a 0° position and the differing position can be a position rotated by the angle of rotation out of the 0° position about the axis of rotation in the direction of rotation of the impeller. The 0° position is basically definable in any way. Appropriately, the angle of rotation is greater than 0°.

The impeller housing and/or the impeller unit can be designed so as to be replaceable. The fluid outlet in the respective replaceable impeller housing and/or the respective replaceable impeller unit can each have one of the at least two positions. In this configuration of the impeller housing and/or of the impeller unit, the impeller housing and/or the impeller unit with the fluid outlet in the one position can be replaced by the impeller housing and/or the impeller unit with the fluid outlet in the differing position in order to adapt the fluid pump to a differing application. Thus, when adapting the fluid pump to a differing application the motor and/or the motor housing and/or the fastening unit need not be replaced. If the impeller housing is formed so as to be replaceable on the motor housing, the impeller of the impeller unit can also remain unchanged. Because of this, the fluid pump can be more easily and also cost-effectively adapted to a differing application. In the respective replaceable impeller housing and/or the respective replaceable impeller unit, the fluid inlet and/or the fluid outlet can be adapted as such. Accordingly, the flow cross-section and/or the shape of these can be adapted.

Alternatively or additionally, the impeller housing and/or the impeller unit can be arrangeable or mountable or fastenable to the motor housing differently. The fluid outlet of the impeller unit can be arrangeable with respect to the motor housing in one of the at least two possible positions. The impeller housing and/or the impeller unit can be rotated by the angle of rotation in the direction of rotation about the axis of rotation and thus arranged or mounted or fastened on the motor housing differently, in order to adapt the fluid pump to a differing application. When adapting the fluid pump to a differing application, the motor and/or the motor housing and/or the fastening unit and/or the impeller housing and/or the impeller unit need not be replaced. Because of this, the fluid pump can be more easily and cost-effectively adapted to a differing application.

With respect to the motor housing, the impeller of the impeller unit can be arranged, in each of the possible positions of the fluid outlet, in an unchanged basic position. In other words, the impeller, when changing the possible position of the fluid outlet, need not be newly mounted or rotated. This can be the case in particular with the replaceable and/or differently arrangeable impeller housing. The impeller of the impeller unit can form a basic unit and remain unchanged with each of the possible positions of the fluid outlet. In other words, the impeller, when changing the possible position of the fluid outlet, need not be adapted or replaced. This can be the case in particular with the replaceable and/or differently arrangeable impeller housing and/or with the replaceable and/or differently arrangeable impeller unit. The motor of the fluid pump can form a basic unit and remain unchanged with each of the possible positions of the fluid outlet. In other words, the motor, when changing the possible position of the fluid outlet, need not be replaced or adapted or replaced.

In order to make possible the described flexibility, all position-relevant contours of the motor in the fluid pump can be formed so as to face away from the impeller unit and all position-relevant contours of the impeller unit so as to axially face away from the motor. The position-relevant contours are in particular the contours which can prevent an arrangement of the fluid outlet of the impeller unit in the at least two possible positions. In particular, the position-relevant contours include the contours which out of the motor and/or out of the impeller unit, axially engage in the impeller unit and/or the motor. Accordingly, the motor and the impeller unit can lie against one another transversely to the axis of rotation and exclusively rotation-transmitting elements of the motor and of the impeller unit and/or the position-irrelevant contours axially engage into one another. The impeller can be completely received in the impeller housing. Further, the motor can realise a cover for the impeller unit and lie on the impeller unit.

The one possible position of the fluid outlet can be appropriately defined as a 0° position. With respect to the motor housing, the 0° position can basically be defined in any way. Since however the motor housing is rotation-unsymmetrical, the respective already defined 0° position is already unambiguously defined with respect to the motor housing. The other possible position differs from the 0° position by the angle of rotation. The angle of rotation is appropriately greater than 0°. The angle of rotation can be freely adjustable or defined fixed. The number of the possible positions in the fluid pump can be two or three or more and is basically defined by the construction of the motor and/or of the impeller unit and/or of the fastening unit. It is to be understood that the fluid outlet in the fluid pump can also assume a non-utilisable position. In the non-utilisable position, further components of the motor and/or of the impeller unit can be for example covered by the fluid outlet and be difficult to access or not at all. However, at least two utilisable positions of the fluid outlet are always present in the fluid pump.

The angle of rotation can be for example 90° or 180° or 270°. The possible positions of the fluid outlet can then correspond to a 0° position and additionally a 90° position or a 180° position or a 270° position. The respective positions differ from the 0° position by the respectively mentioned angle of rotation. In the fluid pump, the fluid outlet can, besides the 0° position, assume one or two or three of the mentioned positions. It is to be understood that the possible positions of the fluid outlet can each correspond to one of the possible applications of the fluid pump.

The angle of rotation can be for example 60° or 120° or 180° or 240° or 300°. The possible positions of the fluid outlet can then correspond to a 0° position and additionally a 60° position or a 120° position or a 180° position or a 240° position or a 300° position. The respective positions differ from the 0° position by the respective mentioned angle of rotation. In the fluid pump, the fluid outlet, besides the 0° position, can assume one or two or three or four or five of the mentioned positions. It is to be understood that the possible positions of the fluid outlets can each correspond to one of the possible applications of the fluid pump.

For example, the angle of rotation can also be freely adjustable. The possible positions of the fluid outlet can then correspond to a 0° position and additionally at least one position with any angle of rotation. Besides the 0° position, the fluid inlet in the fluid pump can then assume any number of further positions.

Accordingly, the fastening unit can be adapted to each of the possible position in such a manner that with each of the possible positions of the fluid outlet it remains unchanged. Accordingly, the motor housing and the motor can then also remain unchanged. The fastening unit can also be adapted to each of the possible positions in such a manner that it is accessible regardless of the respective possible position of the fluid outlet. Accordingly, the impeller housing and/or the impeller unit are/is always accessible to a tool and can be more easily mounted and demounted.

The fastening unit can be for example a screw unit. The screw unit can comprise multiple screw groups each with at least one screw position. The arrangement of the respective screw groups can be adapted to the possible positions of the fluid outlet in such a manner that they are axially accessible on the impeller side regardless of the respective possible position of the fluid outlet. Preferentially, the fastening unit comprises at least three screw points in order to generate a necessary strong compression of a seal between the impeller housing and the motor housing. The fluid outlet can then be advantageously arranged in the respective possible position between the screw groups that are adjacent to one another in the direction of rotation.

The screw point can comprise a screw and a screw opening each. The screw opening can pass through the impeller housing and the motor housing so that the impeller housing and the motor housing can be screwed together by means of the screw via the screw opening. The screw opening is appropriately adapted to the corresponding screw. The arrangement of the respective screw points can be adapted to the respective possible positions of the fluid outlet in such a manner that they are axially accessible on the impeller side regardless of the respective possible position of the fluid outlet. The screw points of the fastening unit can be formed identical to one another in order to simplify the mounting and demounting.

The respective screw groups can be arranged evenly distributed about the axis of rotation. In other words, the screw groups can be arranged rotation-symmetrically about the axis of rotation. The respective screw groups can be identical to one another and/or have an identical distance from the axis of rotation. Because of the rotation symmetry achieved, the impeller housing and/or the impeller unit in particular can be arranged on the motor housing differently. The number of the respective screw groups or the achieved rotation symmetry is then related to the number of the possible positions of the fluid outlet of the impeller unit.

Accordingly, the screw unit can comprise for example exactly four identical screw groups, wherein the respective screw groups are evenly distributed about the axis of rotation and have an identical distance from the axis of rotation. Because of this, the fluid outlet—as described above—can have altogether four possible positions at 0°, 180° and 270°. Alternatively, the screw unit can comprise exactly six identical screw groups, wherein the respective screw groups are evenly distributed about the axis of rotation and are arranged with an identical distance from the axis of rotation. The fluid outlet can then comprise—as described above—altogether six possible positions at 0°, 60°, 120°, 180°, 240° and 300°.

Alternatively to the screw unit, the fastening unit can be a clamping holder. The clamping holder can firmly connect the impeller housing to the motor housing in a force-fitted and/or form-fitted manner. To this end, the motor housing and/or the impeller housing can circumferentially to the axis of rotation overlap one another or lie on top of one another radially or in a radial direction in a clamping region. The clamping holder can then comprise a belt enclosing the clamping region from the outside and a clamping unit. By way of the clamping unit, the belt can be pulled together as a result of which the motor housing and the impeller housing are pressed against one another radially or in a radial direction and because of this are firmly connected force-fittedly and/or form-fittedly. The motor housing and/or the impeller housing can be formed rotation-symmetrically in the clamping region so that the impeller housing can be rotatably mounted on the motor housing as desired. Thus, at the clamping holder the angle of rotation can be any and the fluid outlet, besides the position, can assume at least one further desired position.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

It shows, in each case schematically

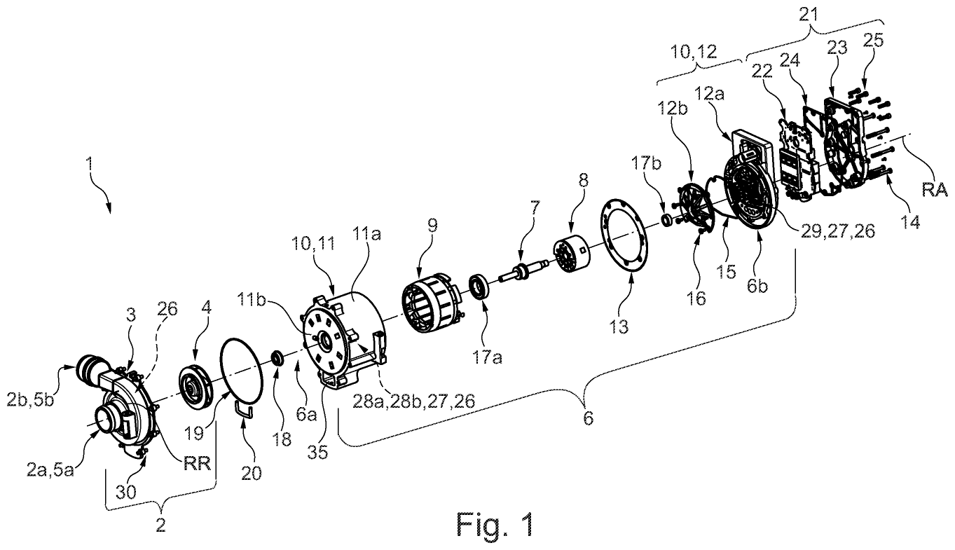

FIG. 1 an exploded view of a fluid pump according to the invention in a first embodiment;

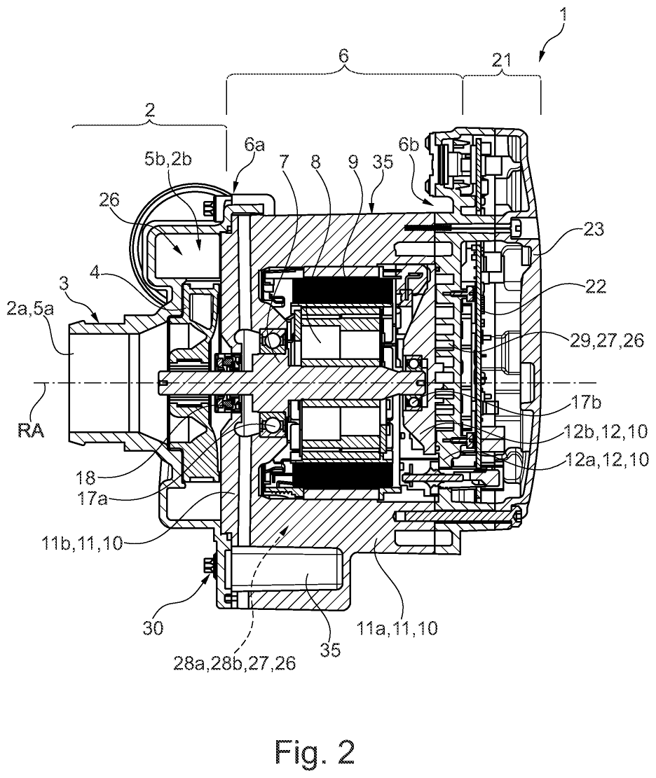

FIG. 2 a sectional view of the fluid pump according to the invention in the first embodiment;

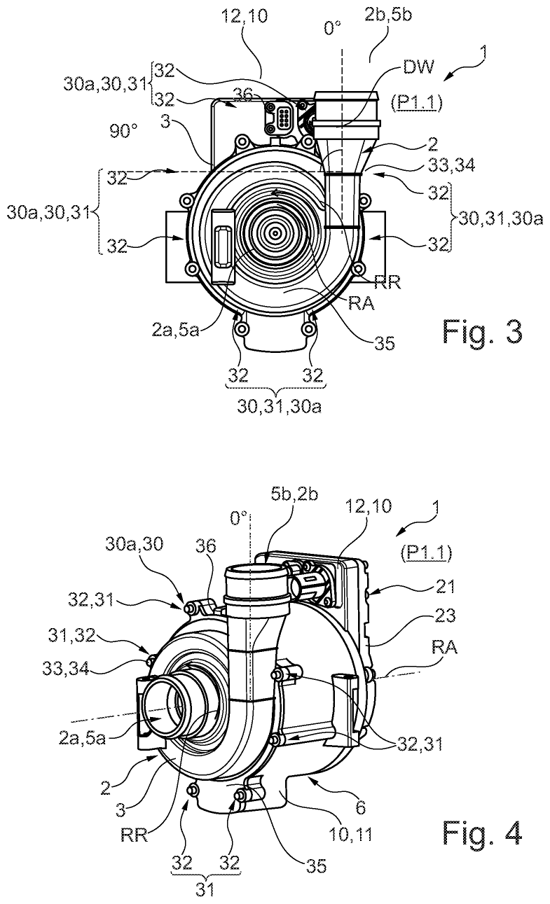

FIG. 3-4 a front view and a view of the fluid pump according to the invention in the first embodiment with a fluid outlet in a 0° position;

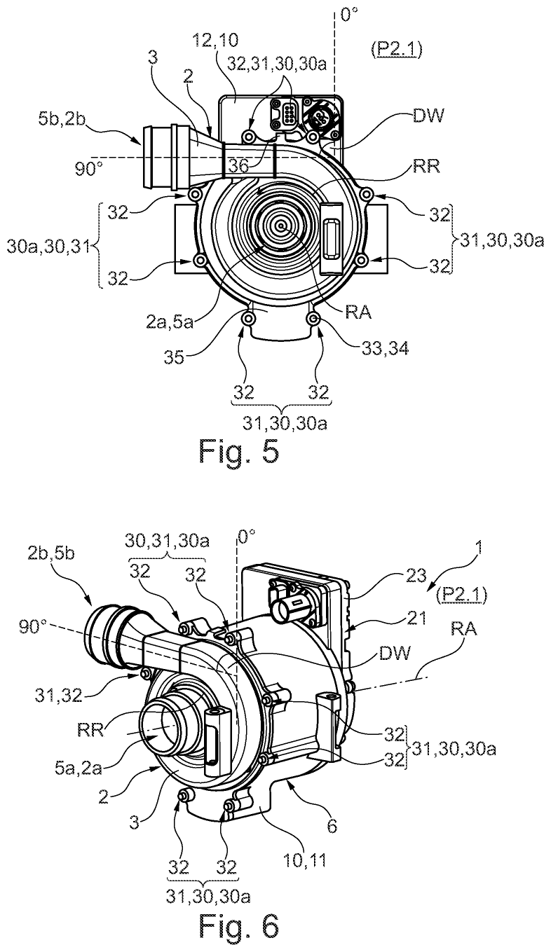

FIG. 5-6 a front view and a view of the fluid pump according to the invention in the first embodiment with the fluid outlet in a 90° position;

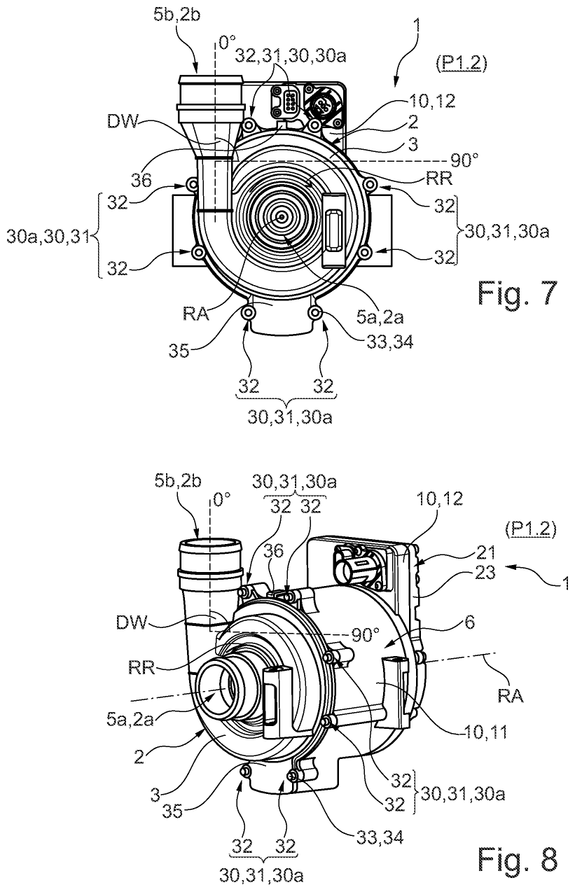

FIG. 7-8 a front view and a view of the fluid pump according to the invention in a second embodiment with the fluid outlet in a 0° position;

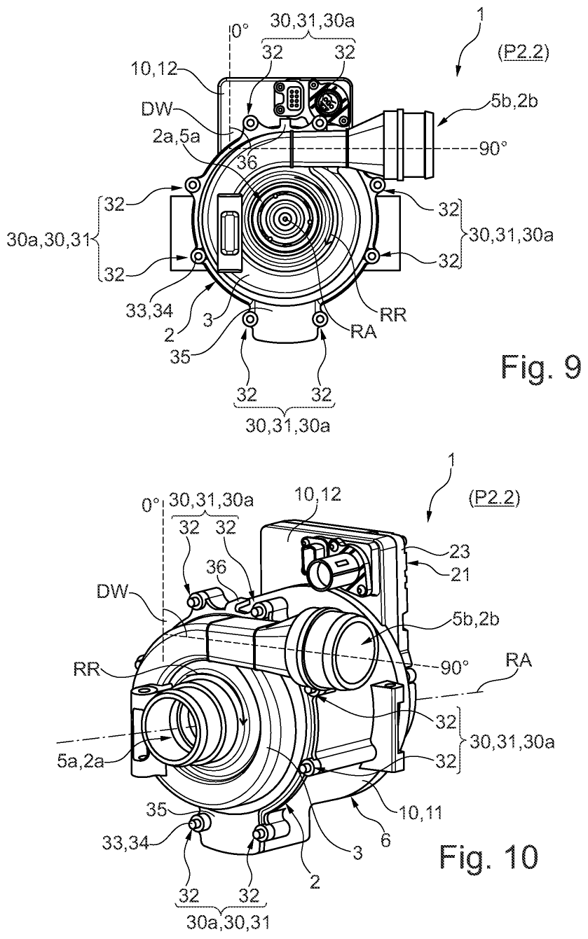

FIG. 9-10 a front view and a view of the fluid pump according to the invention in the second embodiment with the fluid outlet in a 90° position;

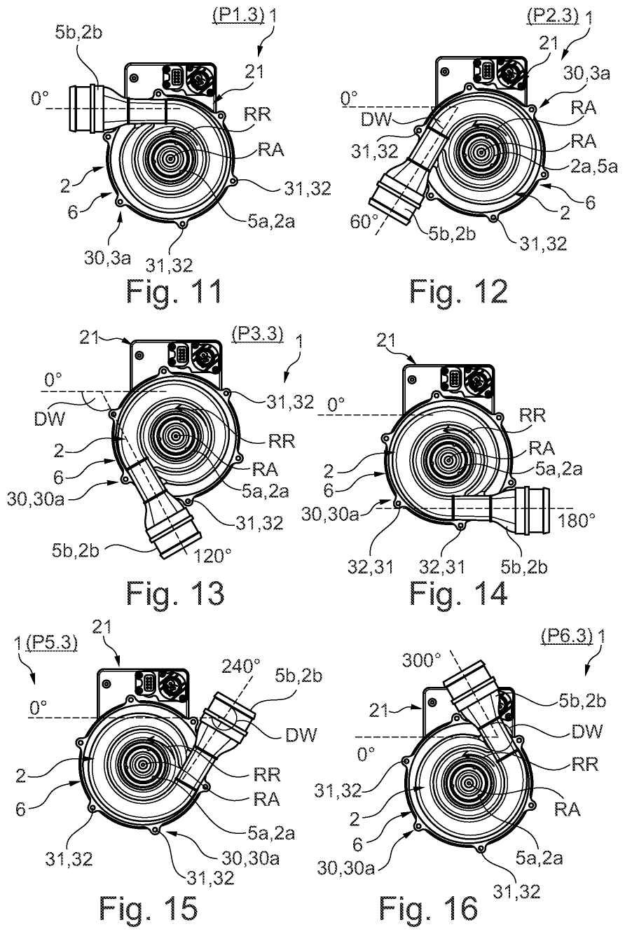

FIG. 11-16 front views of the fluid pump according to the invention in a third embodiment with the fluid outlet in positions differing from one another;

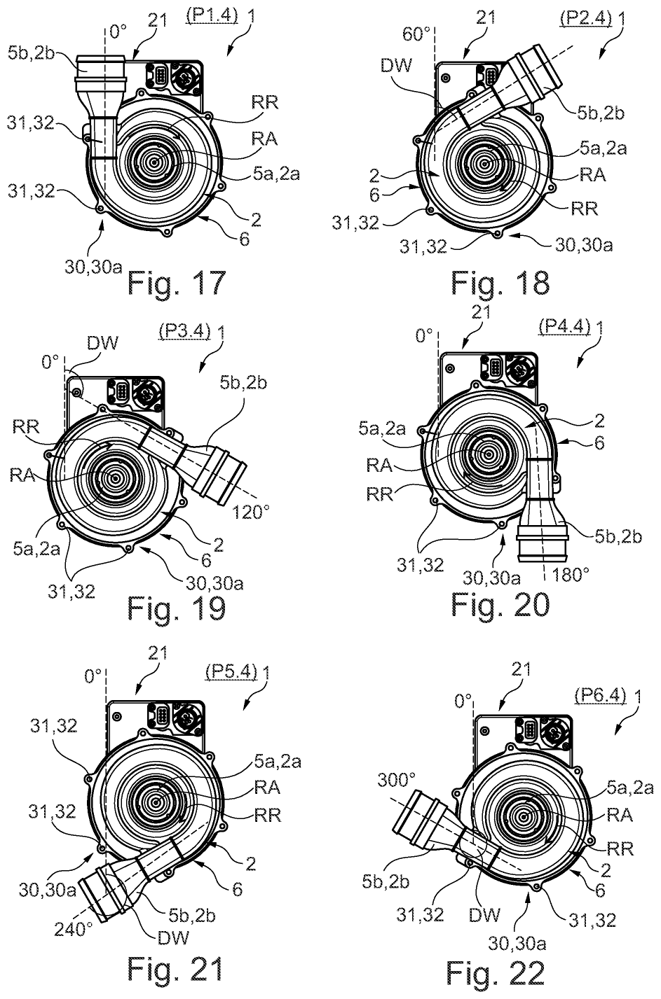

FIG. 17-22 front views of the fluid pump according to the invention in a fourth embodiment with the fluid outlet in positions differing from one another;

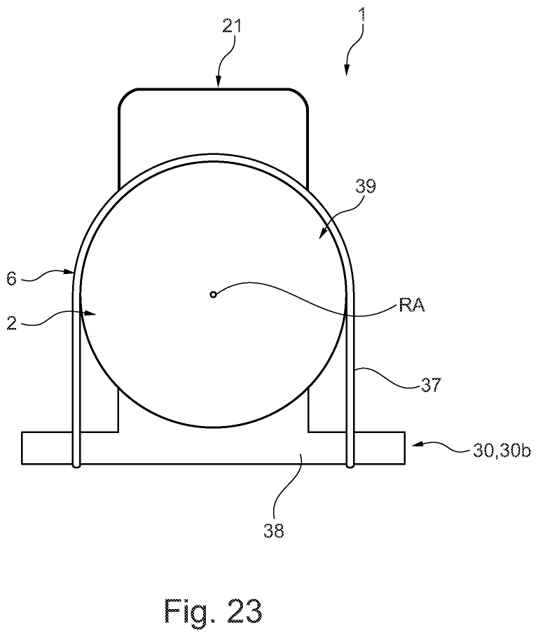

FIG. 23 a view of the fluid pump according to the invention in a fifth embodiment with a clamping holder.

FIG. 1 shows an exploded view of a fluid pump 1 according to the invention in a first embodiment. The fluid pump 1 is provided or designed for a fuel cell system having at least one fuel cell stack of multiple fuel cells. The fuel cell system can be provided or designed in particular for a commercial vehicle. The fluid pump 1 comprises an impeller unit 2 with an impeller housing 3 and an impeller 4. The impeller 4 is rotatable about an axis of rotation RA in a direction of rotation RR.

The impeller unit 2 comprises an inlet side 2a—or a low-pressure side—with a fluid inlet 5a and an outlet side 2b—or a high-pressure side—with a fluid outlet 5b. The inlet side 2a and the outlet side 2b are separated or fluidically connected to one another by the impeller 4. The fluid inlet 5a and the fluid outlet 5b are formed in the impeller housing 3. With respect to the axis of rotation RA, the fluid inlet 5a axially leads to the inlet region 2a, which is formed within the impeller 4. The fluid outlet 5b leads out of the outlet region 2b, which is formed circumferentially about the impeller 4, to the outside and is formed tangentially to a circumferential line which, spaced apart, is circumferential to the axis of rotation RA. Appropriately, the fluid outlet 5b is oriented according to the direction of rotation RR of the impeller 4.

In addition, the fluid pump 1 comprises an electric motor 6. The electric motor 6 can be in particular a permanent magnet synchronous motor. The motor 6 includes a shaft 7 that is rotatable about the axis of rotation RA in the direction of rotation RA, a rotor 8 that is firmly connected to the shaft 7 and a stator 9 receiving the rotor 8. The shaft 7 is drive-connected or non-rotatably connected to the impeller 4. The motor 6 comprises two longitudinal ends 6a and 6b located opposite one another with respect to the axis of rotation RA. The impeller unit 2 is arranged at the longitudinal end 6a of the motor 6.

Further, the motor 6 comprises a motor housing 10 with a pot-shaped housing body 11 and a bottom 12 oriented transversely to the axis of rotation RA. In addition, the motor housing 10 comprises a housing seal 13 which is arranged and sealingly clamped between the housing body 11 and the bottom 12 and which seals the relevant joint towards the outside. The housing body 11 and the bottom 12 are screwed to one another by means of multiple housing screws 14. The housing body 11 comprises a housing wall 11a which, spaced apart, is circumferential to the axis of rotation RA and a separating wall 11b oriented transversely to the axis of rotation RA. The separating wall 11b separates the impeller 4 fluidically from the rotor 8 and the stator 9. The bottom 12 comprises a bottom plate 12a and a cover 12b, wherein the cover 12b closes the bottom plate 12a on the stator side or rotor side or impeller side. Between the bottom plate 12a and the cover 12b a cover seal 15 is arranged or sealingly clamped in, which seals the relevant joint towards the outside. The bottom plate 12a and the cover 12b are screwed to one another by means of multiple cover screws 16.

The stator 9 is received in the motor housing 10 rotationally fixed and the shaft 7 with the rotor 8 is rotatingly received in the housing 10 or in the stator 9. To this end, the fluid pump 1 comprises two bearings 17a and 17b which rotatably mount the shaft 7 at the respective longitudinal ends 6a and 6b of the motor 6. At the longitudinal end 6a, an impeller seal 18 is additionally arranged on the shaft 7.

Further, the fluid pump 1 comprises a sliding ring seal 19. The sliding ring seal 19 is arranged or sealingly clamped between the motor housing 10 and the impeller housing 3 and seals the relevant joint towards the outside. The sliding ring seal 19 is preferentially formed from SiC. Further, the fluid pump 1 comprises a U-seal 20, which is similarly arranged or sealingly clamped between the motor housing 10 and the impeller housing 3. The impeller housing 3 and the motor housing 10 are firmly connected to one another by means of a fastening unit 30—here a screw unit 30a. The screw unit 30a is described in more detail in the following by way of FIG. 3-22.

Further, the fluid pump 1 comprises an inverter 21 for the energy supply of the motor 6. The inverter 21 can be designed for example for converting a direct voltage between 400 V and 860 V. The inverter 21 is arranged on the bottom 12 at the longitudinal end 6b of the motor 6 facing away from the rotor 8 or the stator 12 or the impeller unit 2. The inverter 21 includes a control board 22 and an inverter cover 23, wherein the control board 22 is arranged between the bottom 12 or the bottom plate 12a of the motor housing 10 and the inverter cover 23 facing away from or on the outside of the rotor 8 or the stator 12 or the impeller unit 2. In addition, the inverter 21 includes an inverter seal 24 which is arranged or sealingly clamped between the bottom 12 or the bottom plate 12a and the inverter cover 23 and seals the relevant joint towards the outside. The bottom 12 or the bottom plate 12a and the inverter cover 23 are screwed to one another by means of multiple inverter screws 25.

The fluid pump 1 is designed for delivering a cooling fluid—preferentially a liquid. For this purpose, the fluid pump 1 comprises a guide channel 26 which leads from the fluid inlet 5a on the inlet side 2a to the fluid outlet 5b on the outlet side 2b via the impeller 4. In addition, the guide channel 26 is realised in regions by a cooling fluid jacket 27 formed in the motor housing 10. The cooling fluid jacket 27 includes multiple—here seven—advance channels 28a and one return channel 28b in the housing body 11 and a meander-like or labyrinth-like connecting channel 29 between the bottom plate 12a and the cover 12b. The cooling fluid jacket 27 is delimited towards the outside by the motor housing 10 and the rotor 8 and the stator 9 are not directly impinged or not directly flowed about by the cooling fluid. The cooling fluid itself can be dielectric.

The fuel cell system can be provided in particular for a commercial vehicle. In this case, the fluid pump 1 can be designed in such a manner that the only fluid pump 1 is adequate for cooling the fuel cell system even with multiple fuel cell stacks. Accordingly, the fluid pump 1 can have a maximum electric power between 4,000 W and 6,000 W, preferentially 4,500 W, and/or a maximum rate of delivery between 400 l/min and 700 l/min and/or a maximum pressure between 3 bar and 4 bar, preferentially 3.5 bar, and/or a maximum rotational speed between 5,000/min and 6,000/min, preferentially 5,400/min, and/or a maximum torque between 6.0 Nm and 8.0 Nm. The impeller can have a maximum efficiency between 60% and 70%, preferentially 65%. Here, the maximum values relate to a full-load operation of the fluid pump 1.

FIG. 2 shows a sectional view of the fluid pump 1 according to the invention in the first embodiment. In FIG. 2, in particular the connecting channel 29 of the cooling fluid jacket 27 between the bottom plate 12a and the cover 12b of the bottom 12 of the motor housing 10 is noticeable. The advance channels 28a and the return channel 28b are arranged adjacent to the stator 9 of the motor 6 and the connecting channel 29 is arranged adjacent to the control board 22 of the inverter 21 and to the bearing 17b. Because of this, the stator 9, the control board 22 and the bearing 17b can be indirectly cooled by means of the cooling fluid delivered by the impeller unit 2.

FIG. 3 shows a front view and FIG. 4 shows a view of the fluid pump 1 according to the invention in the first embodiment. Here, the fluid outlet 5b has on the impeller housing 3 a position P1.1, wherein the position P1.1 relates to the axis of rotation RA and corresponds to a 0° position. FIG. 5 shows a front view and FIG. 6 shows a view of the fluid pump 1 according to the invention in the first embodiment. Here, the fluid outlet 5b on the impeller housing 3 has a position P2.1, wherein the position P2.1 relates to the axis of rotation RA and corresponds to a 90° position.

The fluid outlet 5b in the 90° position in FIG. 5-6 is rotated with respect to the 0° position in FIG. 3-4 by an angle of rotation DW of 90° in the direction of rotation RR of the impeller 4 about the axis of rotation RA. The fluid pump 1 with the fluid outlet 5b in the position P1.1 and the fluid pump 1 with the fluid outlet 5b in the position P2.1 are provided for two differing applications of the fluid pump 1. The screw unit 30a in the position P1.1 and the position P2.1 are adapted in such a manner that, regardless of the respective position P1.1 or P2.1 of the fluid outlet 5b, it is axially accessible on the impeller side. In other words, the fluid outlet 5b in the position P1.1 and in the position P2.1 does not overlap the screw unit 30a impeller side. Accordingly, the impeller unit 2 or the impeller housing 3 is freely mountable and demountable in each position P1.1 and P2.1 of the fluid outlet 5b.

The impeller unit 2 and the motor 6 are designed so that for adapting the fluid pump 1 to the differing application merely the impeller housing 3 has to be replaced. Thus, neither the motor 6 with the motor housing 10 nor the impeller 4 of the impeller unit 2 have to be altered. Here, the replacing of the impeller housing 3 is due to a leakage vessel 35 of the motor housing 10 and of a vent bore 36 of the motor housing 10 being covered by the impeller housing 3. Because of the leakage vessel 35 and the vent bore 36 the screw unit 30a is rotation-unsymmetrical and the impeller housing 3 has to be suitably adapted. With a cover of the leakage vessel 35 detached from the impeller housing 3 and the vent bore 36, the impeller housing 3 would not have to be replaced either.

The screw unit 30a comprises multiple—here exactly four—screw groups 31, wherein the respective screw group 31 comprises multiple—here exactly two—screw points 32. The respective screw point 32 is formed by a screw 33 and a screw opening 34 each. The screw 33 and the screw opening 34 are appropriately adapted to one another. The screw opening 34 passes through the impeller housing 3 and the motor housing 10. Regardless of the position P1.1 and P2.1 of the fluid outlet 5b in the fluid pump 1, none of the screw points 32 are covered by the fluid outlet 5b. In addition, the sliding ring seal 19 can be sealingly clamped by way of the four screw groups 31 evenly and sufficiently tightly between the impeller housing 3 and the motor housing 10.

The screw groups 31 and the screw points 32 are formed identically to one another and arranged symmetrically distributed about the axis of rotation RA. The respective screw groups 31 lie, with respect to the axis of rotation RA, opposite one another in pairs in each case. The fluid outlet 5b is arranged in the respective position P1.1 or P2.1 between the adjacent screw groups 31 and does not cover these on the impeller side, as is noticeable in particular in FIG. 3 and FIG. 5.

It is to be understood that in the fluid pump 1, the fluid outlet 5b can also assume a 180° position or a 270° position. It is to be understood, further, that the impeller unit 2 or the impeller housing 3 is formed so as to be replaceable. It is to be understood in addition that the impeller housing 3 is adapted in such a manner that by the differing arrangement of the impeller housing 3 on the motor 6 or on the motor housing 10 the functionality of the fluid pump 1 and in particular of the guide channel 26 or of the cooling fluid jacket 27 is not negatively affected. It is to be understood, also, that the position in FIG. 5-6 can be defined as a new 0° position. The 0° position in FIG. 3-4 would then correspond to a new 270° position and would, with respect to the new 0° position, be rotated in the direction of rotation RR of the impeller 4 about the axis of rotation by the angle of rotation DW of 270°.

FIG. 7 shows a front view and FIG. 8 shows a view of the fluid pump 1 according to the invention in a second embodiment. Here, the fluid outlet 5b on the impeller housing 3 has the position P1.2, wherein the position P1.2 also relates to the axis of rotation RA and corresponds to a 0° position. FIG. 9 shows a front view and FIG. 10 shows a view of the fluid pump 1 according to the invention in the second embodiment. Here, the fluid outlet 5b on the impeller housing 3 has the position P2.2, wherein the position P2.2 relates to the axis of rotation RA and corresponds to a 90° position.

The fluid pump 1 with the fluid outlet 5b in the position P1.2 and the fluid pump with the fluid outlet 5b in the position P2.2 are adapted to two differing applications of the fluid pump 1. Accordingly, for adapting the fluid pump 1 to the respective differing application merely the impeller housing 3 has to be replaced—analogously to the fluid pump 1 in the first embodiment. The motor 6 with the motor housing 10 and the impeller 4 of the impeller unit 2 need not be replaced for this purpose.

In the second embodiment of the fluid pump according to FIG. 7-10, the impeller 4 has a differing direction of rotation RR compared with the first embodiment of the fluid pump 1 in FIG. 1-6. Since the fluid outlet 5b is appropriately oriented according to the direction of rotation RR of the impeller 5b, the 0° positions and the 90° positions in the first embodiment and in the second embodiment of the fluid pump 1 differ from one another. The fluid outlets 5b in the respective 0° positions and in the respective 90° positions each have an angle of 90° to one another.

By changing the direction of rotation RR of the impeller 4, the fluid pump 1 can be adapted to further applications. For adapting the fluid pump 1 to this further application, merely the impeller unit 2 has to be replaced in the fluid pump 1 in the first embodiment and the direction of rotation RR of the impeller 4 of the impeller unit 2 to be replaced. The motor 6 with the motor housing 10 need not be replaced for this purpose.

Altogether, the fluid pump 1 in the first and second embodiment with the identically configured motor 6 can be adapted to multiple differing applications by replacing the impeller housing 3 and/or the impeller unit 2.

FIG. 11 to FIG. 16 show front views of the fluid pump 1 according to the invention in a third embodiment. In FIG. 11-16, the fastening unit 30 is the screw unit 30, but which is formed differently to the screw unit 30a in FIG. 1-10. In FIG. 11-16, the screw unit comprises altogether six screw groups 31 each with a screw point 32. The screw groups 31 or the screw points 32 are formed identically to one another, are evenly distributed about the axis of rotation RA and have an identical distance from the axis of rotation RA. Because of this, the screw unit 30a is formed 60° rotation-symmetrically. This configuration of the screw unit 30a is possible among other things because the motor housing 10 does not comprise a leakage vessel 35 and no vent bore 36. Because of this, the impeller unit 2 and/or the impeller housing 3 and accordingly the fluid outlet 5b can be arranged on the motor 6 and/or the motor housing 10 differently. According to the 60° rotation-symmetrical screw unit 30a, the fluid outlet 5b can assume six positions that are distinct from one another, which differ by 60° from one another.

In FIG. 11, the fluid outlet 5b is in the 0° position P1.3, in FIG. 12, in the 60° position P2.3, in FIG. 13 in the 120° position P3.3, in FIG. 14 in the 180° position P4.3, in FIG. 15 in the 240° position P5.3, in FIG. 16 in the 300° position P6.3. The positions P2.3, P3.3, P4.3, P5.3, P6.3 differ from one another by the mentioned angles of rotation of 60°, 120°, 180°, 240° and 300° from the 0° position P1.3. The positions P1.3, P2.3, P3.3, P4.3, P5.3, P6.3 following one another differ from one another by an angle of 60°, which is defined by the configuration of the screw unit 30a. Possibly, the 300° position P3.6 may not be utilisable since connectors of the inverter 21 are axially covered.

FIGS. 17 to 22 show front views of the fluid pump 1 according to the invention in a fourth embodiment. The screw unit 30a is formed in the fourth embodiment identically to the third embodiment. The third and the fourth embodiment merely differ from one another by the direction of rotation RR, which in the third and fourth embodiment are directed opposite to one another. In FIG. 17, the fluid outlet 5b is situated in the 0° position P1.4, in FIG. 18 in the 60° position P2.4, in FIG. 19 in the 120° position P3.4, in FIG. 20 in the 180° position P4.4, in FIG. 21 in the 240° position P5.4, in FIG. 22 in the 300° position P6.4. The positions P2.4, P3.4, P4.4, P5.4, P6.4 differ from one another by the mentioned angles of rotation of 60°, 120°, 180°, 240° and 300° from the 0° position P1.4. The positions P1.4, P2.4, P3.4, P4.4, P5.4, P6.4 following one another differ from one another by an angle of 60° which is defined by the configuration of the screw unit 30a. Possibly, the 60° position P2.4 may not be utilisable since connectors of the inverter 21 are axially covered here.

It should be noted at this point that the fluid pump 1 in the third and in the fourth embodiment as such can be mounted to a bracket in four distinct mounting positions. The respective mounting positions of the fluid pump 1 can differ with respect to the bracket by the arrangement of the inverter 21 radially projecting from the motor housing 10 on one side. The fluid pump 1 can comprise for example altogether four different mounting positions with respect to the bracket, which are rotated relative to one another about the axis of rotation RA by 90°. Altogether, 6×4=24 possible positions of the fluid outlet 5b thus materialise in the mounted fluid pump 1 in the respective embodiment with respect to the bracket.

FIG. 23 shows a view of the fluid pump 1 according to the invention in a fifth embodiment. For the sake of clarity, no fluid inlet 5a and no fluid outlet 5b are shown here. In the fifth embodiment, the fastening unit 30 is a clamping holder 30b. The clamping holder 30b comprises a belt 37 and a clamping unit 38. In a clamping region 39, the clamping holder 30b encloses the clamping holder 30b, the impeller housing 3 and the motor housing 10 and fixes these force-fittedly and/or form-fittedly against one another. The motor housing 10 and the impeller housing 3 are formed rotation-symmetrically in the clamping region 39 so that the fluid outlet 5b can assume a position that can differ from the 0° position by any angle of rotation DW greater than 0°.

The specification can be best understood with reference to the following Numbered Paragraphs:

Numbered Paragraph 1. A fluid pump (1) for a fuel cell system having at least one fuel cell stack of multiple fuel cells,
wherein the fluid pump (1) comprises an impeller unit (2) for delivering a cooling fluid having an impeller (4) rotating about an axis of rotation (RA) in a direction of rotation (RR) and an impeller housing (3) receiving the impeller (4),
wherein the fluid pump (1) comprises an electric motor (6) for driving the impeller (4) with a rotation-unsymmetrical motor housing (10),
wherein the impeller unit (2) is arranged, with respect to the axis of rotation (RA), at an axial longitudinal end (6a) of the motor (6) and the impeller housing (3) is firmly connected to the motor housing (10) by means of a fastening unit (30),
wherein on the impeller housing (3) an, with respect to the axis of rotation (RA), axial fluid inlet (5a) of the impeller unit (2) and a fluid outlet (5b) of the impeller unit (2) oriented corresponding to the direction of rotation (RR) and tangentially to a circumferential line which, spaced apart, is circumferential to the axis of rotation (RA) are formed,
   characterised
in that the impeller unit (2) and the motor (6) are formed in such a manner that the fluid outlet (5b) of the impeller housing (3) with respect to the motor housing (10) can be arranged in one of at least two possible positions (P1.1, P2.1), and
in that the possible positions (P1.1, P2.1) of the fluid outlet (5b) differ from one another by an angle of rotation (DW) about the axis of rotation (RA) in the direction of rotation (RR).

Numbered Paragraph 2. The fluid pump according to Numbered Paragraph 1, characterised
in that the impeller housing (3) is formed so as to be replaceable, and/or
in that the impeller housing (3) can be arranged on the motor housing (10) differently, and/or
in that the impeller unit (2) is formed so as to be replaceable, and/or
in that the impeller unit (2) can be arranged on the motor housing (10) differently.

Numbered Paragraph 3. The fluid pump according to either one of Numbered Paragraph 1 or 2,

characterised
in that the impeller housing (3) is formed so as to be replaceable and the fluid outlet (5b) of the impeller unit (2) in the respective replaceable impeller housing (3) comprises one of the at least two possible positions (P1.1, P2.1) each, and/or
in that the impeller housing (3) can be arranged on the motor housing (10) differently and because of this the fluid outlet (5b) of the impeller unit (2) can be arranged with respect to the motor housing (10) in one of the at least two possible positions (P1.1, P2.1), and/or
in that the impeller unit (2) is formed so as to be replaceable and the fluid outlet (5b) of the impeller unit (2) in the respective replaceable impeller unit (2) in each case has one of the at least two possible positions (P1.1, P2.1), and/or
in that the impeller unit (2) can be arranged on the motor housing (10) differently and because of this the fluid outlet (5b) of the impeller unit (2) with respect to the motor housing (10) can be arranged in one of the at least two possible positions (P1.1, P2.1).

Numbered Paragraph 4. The fluid pump according to any one of the preceding Numbered Paragraphs,

characterised
in that the impeller (4) of the impeller unit (2) is arranged with respect to the motor housing (10) in each of the possible positions (P1.1, P2.1) of the fluid outlet (5b) in an unchanged basic position, and/or
in that the impeller (4) of the impeller unit (2) forms a basic unit and in each of the possible positions (P1.1, P2.1) of the fluid outlet (5b) remains unchanged, and/or
in that the motor (6) of the fluid pump (1) forms a basic unit and in each of the possible positions (P1.1, P2.1) of the fluid outlet (5b) remains unchanged.

Numbered Paragraph 5. The fluid pump according to any one of the preceding Numbered Paragraphs,

characterised
in that the angle of rotation (DW) amounts to 90° or 180° or 270°, or
in that the angle of rotation (DW) amounts to 60° or 120° or 180° or 240° or 300°, or
in that the angle of rotation (DW) is greater than 0°.

Numbered Paragraph 6. The fluid pump according to any one of the preceding Numbered Paragraphs,

characterised
in that the fastening unit (30) is adapted to each of the possible positions (P1.1, P2.1) in such a manner that in each of the possible positions (P1.1, P2.1) of the fluid outlet (5b) it remains unchanged, and/or
in that the fastening unit (30) is adapted to each of the possible positions (P1.1, P2.1) in such a manner that, regardless of the respective position (P1.1, P2.1) of the fluid outlet (5b), it is accessible.

Numbered Paragraph 7. The fluid pump according to any one of the preceding Numbered Paragraphs,

characterised
in that the fastening unit (30) is a screw unit (30a), wherein the screw unit (30a) comprises multiple screw groups (31) each with at least one screw point (32), and
in that the arrangement of the respective screw groups (31) is adapted to the possible positions (P1.1, P2.1) of the fluid outlet (5b) in such a manner that, regardless of the respective possible position (P1.1, P2.1) of the fluid outlet (5b), they are axially accessible on the impeller side.

Numbered Paragraph 8. The fluid pump according to Numbered Paragraph 7, characterised
in that the fluid outlet (5b) in the respective possible position (P1.1, P2.1) is arranged between the screw groups (31) that are adjacent in the direction of rotation (RR).

Numbered Paragraph 9. The fluid pump according to Numbered Paragraph 7 or 8,

characterised
in that the respective screw points (32) are identical to one another, and/or
in that the respective screw groups (31) are identical to one another, and/or
in that the respective screw groups (31) are arranged evenly distributed about the axis of rotation (RA), and/or
in that the respective screw groups (31) have an identical distance from the axis of rotation (RA).

Numbered Paragraph 10. The fluid pump according to any one of the Numbered Paragraph 1 to 6,

characterised
in that the fastening unit (30) is a clamping holder (30b), wherein the clamping holder (30b) firmly connects the impeller housing (3) to the motor housing (10) in a force-fitted and/or form-fitted manner, and
in that the clamping holder is formed in such a manner that the impeller housing (3), with respect to the motor housing (10), can be fastened with any angle of rotation (DW) greater than 0°.

Numbered Paragraph 11. The fluid pump according to any one of the preceding Numbered Paragraphs,

characterised
in that all position-relevant contours of the motor (6) are formed so as to axially face away from the impeller unit (2) and all position-relevant contours of the impeller unit (2) so as to axially face away from the motor (6), and/or
in that the motor (6) and the impeller unit (2) lie on one another transversely to the axis of rotation (RA) and exclusively rotation-transmitting elements of the motor (6) and of the impeller unit (2) axially engage into one another, and/or
in that the impeller (4) is completely received in the impeller housing (3), and/or
in that the motor (6) forms a cover for the impeller unit (2) and lies on the impeller unit (2).

1. A fluid pump for a fuel cell system having at least one fuel cell stack of multiple fuel cells,
wherein the fluid pump comprises an impeller unit for delivering a cooling fluid having an impeller rotating about an axis of rotation in a direction of rotation (RR) and an impeller housing receiving the impeller,
wherein the fluid pump comprises an electric motor for driving the impeller with a rotation-unsymmetrical motor housing,
wherein the impeller unit is arranged, with respect to the axis of rotation, at an axial longitudinal end of the motor and the impeller housing is firmly connected to the motor housing by means of a fastening unit,
wherein on the impeller housing an, with respect to the axis of rotation, axial fluid inlet of the impeller unit and a fluid outlet of the impeller unit oriented corresponding to the direction of rotation and tangentially to a circumferential line which, spaced apart, is circumferential to the axis of rotation are formed,
characterised
in that the impeller unit and the motor are formed in such a manner that the fluid outlet of the impeller housing with respect to the motor housing can be arranged in one of at least two possible positions, and
in that the possible positions of the fluid outlet differ from one another by an angle of rotation about the axis of rotation in the direction of rotation.

2. The fluid pump according to claim 1,
characterised
in that the impeller housing is formed so as to be replaceable, and/or
in that the impeller housing can be arranged on the motor housing differently, and/or
in that the impeller unit is formed so as to be replaceable, and/or
in that the impeller unit can be arranged on the motor housing differently.

3. The fluid pump according to claim 1,
characterised
in that the impeller housing is formed so as to be replaceable and the fluid outlet of the impeller unit in the respective replaceable impeller housing comprises one of the at least two possible positions each, and/or
in that the impeller housing can be arranged on the motor housing differently and because of this the fluid outlet of the impeller unit can be arranged with respect to the motor housing in one of the at least two possible positions, and/or
in that the impeller unit is formed so as to be replaceable and the fluid outlet of the impeller unit in the respective replaceable impeller unit in each case has one of the at least two possible positions, and/or
in that the impeller unit can be arranged on the motor housing differently and because of this the fluid outlet of the impeller unit with respect to the motor housing can be arranged in one of the at least two possible positions.

4. The fluid pump according to claim 1,
characterised
in that the impeller of the impeller unit is arranged with respect to the motor housing in each of the possible positions of the fluid outlet in an unchanged basic position, and/or
in that the impeller of the impeller unit forms a basic unit and in each of the possible positions of the fluid outlet remains unchanged, and/or
in that the motor of the fluid pump forms a basic unit and in each of the possible positions of the fluid outlet remains unchanged.

5. The fluid pump according to claim 1,
characterised
in that the angle of rotation amounts to 90° or 180° or 270°, or
in that the angle of rotation amounts to 60° or 120° or 180° or 240° or 300°, or
in that the angle of rotation is greater than 0°.

6. The fluid pump according to claim 1,
characterised
in that the fastening unit is adapted to each of the possible positions in such a manner that in each of the possible positions of the fluid outlet it remains unchanged, and/or
in that the fastening unit is adapted to each of the possible positions in such a manner that, regardless of the respective position of the fluid outlet, it is accessible.

7. The fluid pump according to claim 1,
characterised
in that the fastening unit is a screw unit, wherein the screw unit comprises multiple screw groups each with at least one screw point, and
in that the arrangement of the respective screw groups is adapted to the possible positions of the fluid outlet in such a manner that, regardless of the respective possible position of the fluid outlet, they are axially accessible on the impeller side.

8. The fluid pump according to claim 7,
characterised
in that the fluid outlet in the respective possible position is arranged between the screw groups that are adjacent in the direction of rotation.

9. The fluid pump according to claim 7,
characterised
in that the respective screw points are identical to one another, and/or
in that the respective screw groups are identical to one another, and/or
in that the respective screw groups are arranged evenly distributed about the axis of rotation, and/or
in that the respective screw groups have an identical distance from the axis of rotation.

10. The fluid pump according to claim 1,
characterised
in that the fastening unit is a clamping holder, wherein the clamping holder firmly connects the impeller housing to the motor housing in a force-fitted and/or form-fitted manner, and
in that the clamping holder is formed in such a manner that the impeller housing, with respect to the motor housing, can be fastened with any angle of rotation greater than 0°.

11. The fluid pump according to claim 1
in that all position-relevant contours of the motor are formed so as to axially face away from the impeller unit and all position-relevant contours of the impeller unit so as to axially face away from the motor, and/or
in that the motor and the impeller unit lie on one another transversely to the axis of rotation and exclusively rotation-transmitting elements of the motor and of the impeller unit axially engage into one another, and/or
in that the impeller is completely received in the impeller housing, and/or
in that the motor forms a cover for the impeller unit and lies on the impeller unit.
